(19) United States
(12) Patent Application Publication
(10) Pub. No.: US 2014/0124091 A1
(43) Pub. Date: May 8, 2014

(54) FIXED POSITION CARBON DIOXIDE DISCHARGE HORN

(71) Applicant: QUARK LIMITED, LDC, Belieze City (BZ)

(72) Inventors: Robert B. Evans, Belvidere, IL (US); Robert W. Hallock, Chicago, IL (US)

(73) Assignee: Quark Limited, LDC, Belieze City (BZ)

(21) Appl. No.: 13/669,654

(22) Filed: Nov. 6, 2012

(51) Int. Cl. F25C 3/00; F16L 59/02; B65B 1/00

(52) U.S. Cl. CPC F25C 3/00; B65B 1/00; F16L 59/02
USPC 141/69; 239/14.2; 138/140

(57) ABSTRACT

A device to connect to a source of carbon dioxide for dispensing dry ice. The device includes discharge horn and an adaptor which may be bent and which supports discharge horn. A bag is removably attached to discharge horn to collect the dry ice produced. An insulating sleeve may be removably disposed about discharge horn.

### CROSS REFERENCE TO RELATED APPLICATIONS

None.

### FIELD OF THE INVENTION

The invention relates to a discharge horn for dispensing dry ice, and more particularly, to a discharge horn that connects directly to a source of CO₂.

### BACKGROUND OF THE INVENTION

Dry ice snow (also sometimes referred to as CO₂ snow) is used for a variety of applications, for example in refrigeration, cooling, and freezing applications. Many of these different applications involve depositing the dry ice snow onto an object for shipping before the object is packaged, or into a package containing an object. In either instance, the dry ice snow keeps the object cold during transportation or shipping.

Many conventional applications utilize dry ice snow dispensers (such as discharge horns or devices with skirts) in fixed positions above a conveyor belt or other means for moving the object/packages. As the objects/packages pass underneath the dry ice snow dispensers, the dispensers deposit the dry ice snow onto the objects or into the packages.

For example, U.S. Pat. No. 4,444,023 discloses a snow horn used in association with a conveyor belt in freezer. In addition, U.S. Pat. No. 4,652,287 discloses a large hood that is used to create a large rectangular area under which dry ice snow can be deposited onto an object.

Some conventional applications utilize a canister or other chamber connected to a CO₂ source to make dry ice snow. These devices allow for dry ice snow to be made and deposited into the canister or other chamber, and then manually applied onto objects, into packages, or used as needed. For example, U.S. Pat. No. 5,148,679 discloses an apparatus that can be connected to a CO₂ tank to produce dry ice in a bag within a canister. Similarly, U.S. Pat. No. 3,677,020 discloses a valve that can be placed upon a CO₂ tank and used, for example, with a hose to produce dry ice snow in a container.

In contrast to those fixed discharge horns, there are known movable discharge horns. For example, U.S. Pat. No. 6,447,377 discloses a gun shaped handle to be used for a dry ice snow blasting process for cleaning The gun handle is intended to be gripped by only one hand.

While these devices are all presumably effective for their intended purposes, there remains a need for a simple and portable device that allows for the rapid creation of dry ice snow. Moreover, there remains a need for such a device that can provide simple storage and movement means for the dry ice snow.

The present invention is directed to providing a device that can provide these benefits, as well as others.

### SUMMARY OF THE INVENTION

In one aspect of the present invention, the present invention is directed towards a dry ice dispensing device that includes a discharge horn and an adaptor for connecting the discharge horn to a source of CO₂, preferably a tank of liquid CO₂ which produces gaseous CO₂.

In some embodiments of the present invention, the adaptor is bent. Such a configuration will allow a larger container to be positioned below the discharge horn—without needlessly increasing the distance between the source of CO₂ and the discharge horn.

In other words, the size of the container that can be placed below a discharge horn is typically limited by the distance between the source of CO₂ and the discharge horn. In order to increase this size, the distance between the source of CO₂ and the discharge horn is increased. However, this increase in distance can create problems as the discharge horn extends too far away from the source of CO₂, which in turn creates a bulky device that is physically undesirable. In addition, if a bag or other container is attached to the discharge horn, the increased distance will move the center of gravity of the system, and may cause the device or the source of CO₂ to tip over.

A bent adaptor, on the other hand, will allow the discharge horn to be placed at an angle relative to the longitudinal axis of the source of CO₂. This configuration will allow a larger container to be placed below the discharge horn without increasing the distance between the discharge horn and the source of CO₂.

In another embodiment, a bag is removably attached to the discharge horn. The bag may include an opening, preferably at the bottom, that is completely selectively closable, and an opening, preferably, at the top, that is partially selectively closable, and partially opened. Such a configuration will allow for a better attachment to the discharge horn, as the partially selectively closable portion can be opened, creating an opening larger than the discharge horn. Once the discharge horn is inserted into the opening, the selectively closable portion can be closed, allowing the bag to attach to the discharge horn. In order to better secure the bag, the bag includes a strap.

Further, the discharge horn may be tapered, or include other structure to assist in the securement of the bag.

Such a bag is believed to provide a simple container that can easily attached/reattach to the discharge horn, and at the same time, can collect solid CO₂ snow and be used to move same—instead of requiring a second container. In addition, such a bag can easily be removed and stored to allow the device to produce dry ice snow and deposit same directly into a desired container instead of the bag.

Further, in another embodiment, the device includes a removable insulating sleeve disposed about the discharge horn. Since the discharge horn involves the phase change of carbon dioxide, one of ordinary skill in the art will appreciate that the discharge horn will have a very low temperature. In order to provide a position on the discharge horn that can be safely handled, an insulating sleeve can be removable attached to about the discharge horn. Preferably, the inner surface of the sleeve has a material with a higher gripping ability (a higher coefficient of friction) compared to a material on the outer surface.

Again, such a sleeve can be used to safely grip the discharge horn, for example, when removing or attaching the bag.

These benefits, as well as others, will be readily apparent to those of ordinary skill in the art in view of the following detailed description and attached drawings.

It is to be understood that the aspects and objects of the present invention described above may be combinable and that other advantages and aspects of the present invention will become apparent to those having ordinary skill in the art upon reading the following description of the drawings and the detailed description thereof.

### BRIEF DESCRIPTION OF THE DRAWINGS

The present invention will become more fully apparent from the following description and appended claims, taken in conjunction with the accompanying drawings. Understanding that the accompanying drawings depict only typical embodiments, and is, therefore, not to be considered to be limiting of the scope of the present disclosure, the embodiments will be described and explained with specificity and detail in reference to the accompanying drawings as provided below.

FIG. 1 is a side elevated view of a device according to one or more embodiments of the present invention;

FIG. 2 is a side cut away elevated view of another discharge horn according to one or more embodiments of the present invention;

FIG. 3 is a side elevated view of a discharge horn according to one or more embodiments of the present invention;

FIG. 4 is a side elevated view of another discharge horn according to one or more embodiments of the present invention;

FIG. 5 is a side elevated view of a bag according to one or more embodiments of the present invention;

FIG. 6A is a top view of an insulating sleeve according to one or more embodiments of the present invention;

FIG. 6B is a bottom view of the insulating sleeve shown in FIG. 6A; and,

FIG. 6C is a side elevated exploded view of the insulating sleeve shown in FIG. 6A.

### DETAILED DESCRIPTION OF THE DRAWINGS

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

Reference throughout this description to features, advantages, objects or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, any discussion of the features and advantages, and similar language, throughout this specification may, but does not necessarily, refer to the same embodiment.

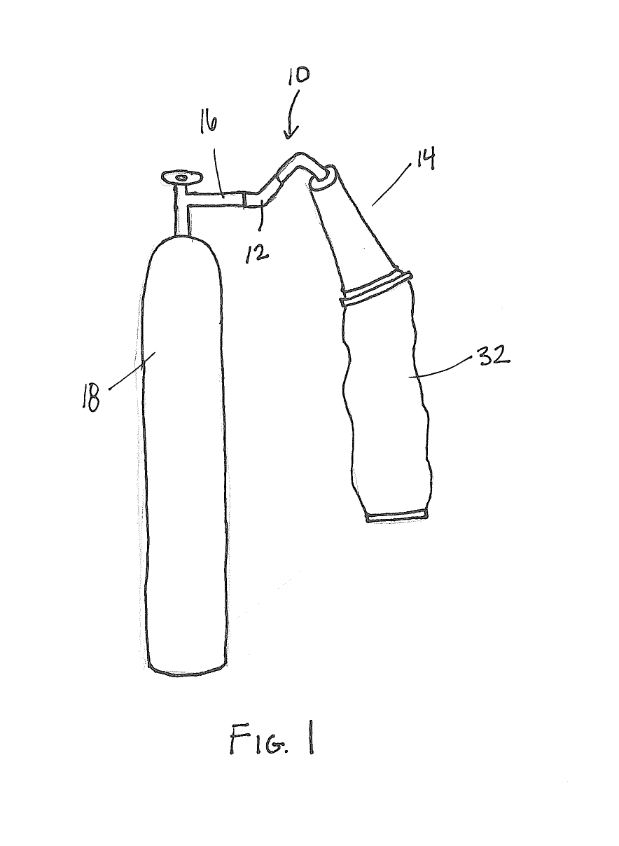

As shown in FIG. 1, device 10 includes, generally, adaptor 12 and discharge horn 14 and is connected with adaptor 12 to carbon dioxide source 16, preferably tank 18.

In addition to connecting discharge horn 14 to carbon dioxide source 16, adaptor 12 supports discharge horn 14 in a fixed position. By “fixed position” it is meant that once adaptor 12 and discharge horn 14 are attached to carbon dioxide source 16, the discharge horn 14 does not move in relation to carbon dioxide source 16. One of ordinary skill in the art will appreciate that given that adaptor 12 supports the discharge horn 14, it should be made out of material that is strong enough for same. As will be appreciated by one of ordinary skill in the art, it is preferred that the components of device 10, like adaptor 12, are threaded to allow the various components to be connected.

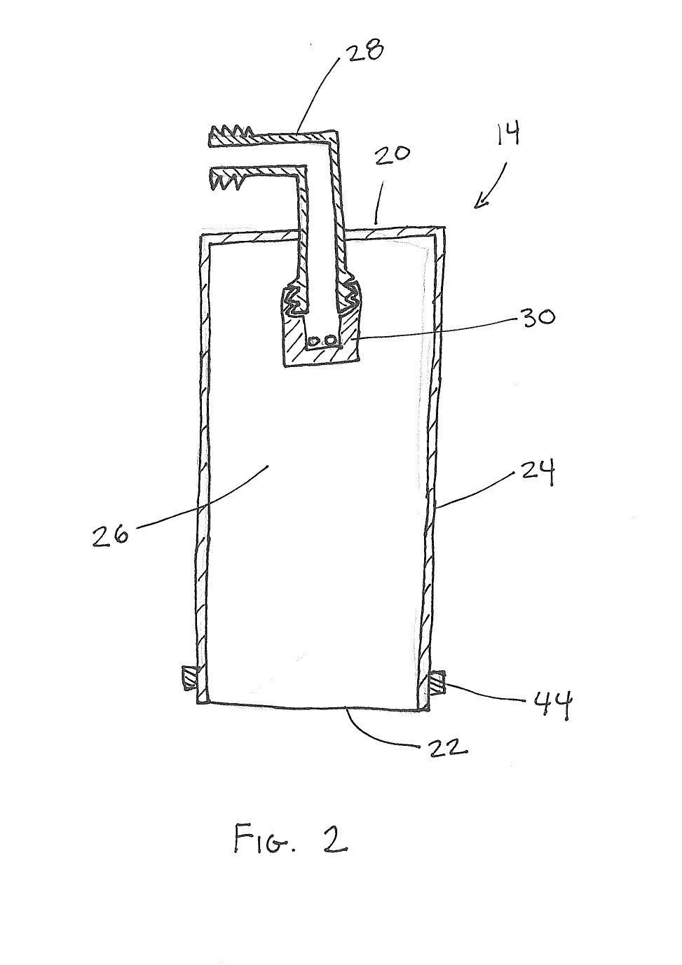

As can be seen in FIG. 2, discharge horn 14 typically includes top end 20, bottom end 22, outer surface 24, inner space 26, and conduit 28. In a preferred design, conduit 28 extends out of top end 20, and includes a 90 degree angle. Again, it should be appreciated that conduit 28 may be threaded for connectivity.

Bottom end 22 is open so that dry ice snow can exit discharge horn 14.

In order to increase the production of the dry ice snow, discharge valve 30 may be located in inner space 26. Discharged valve 30 is preferably distally space from open bottom end 22. A preferred discharge valve 30 is disclosed in U.S. patent application Ser. No. 13/621,970 (filed on Sep. 18, 2012), the entirety of which is incorporated herein by reference.

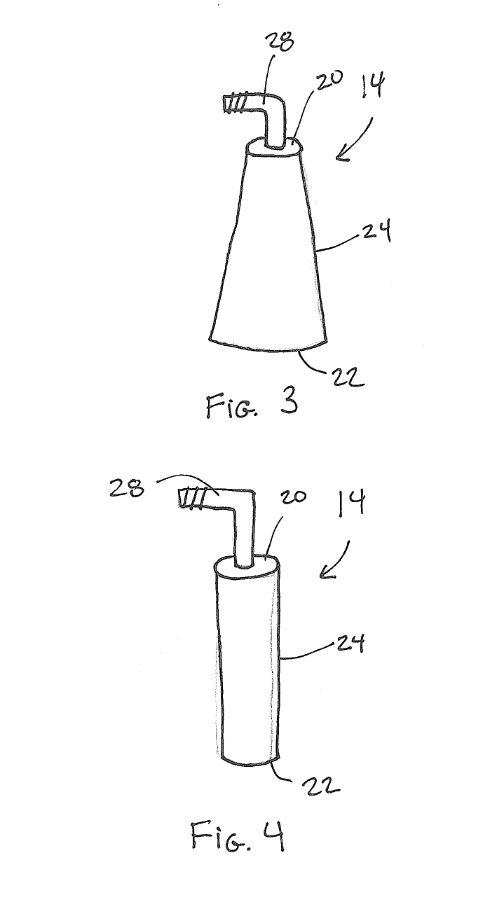

As shown in FIG. 4, outer surface 24 can be straight (meaning top end 20 and bottom end 22 have the same size). Alternatively as shown in FIG. 3, it is contemplated that outer surface 24 is tapered (meaning bottom end 22 has a larger size than top end 24).

One benefit of having a tapered outer surface 24 (FIG. 3) is that outer surface 24 can support bag 32—which collects the dry ice snow. See, FIG. 1.

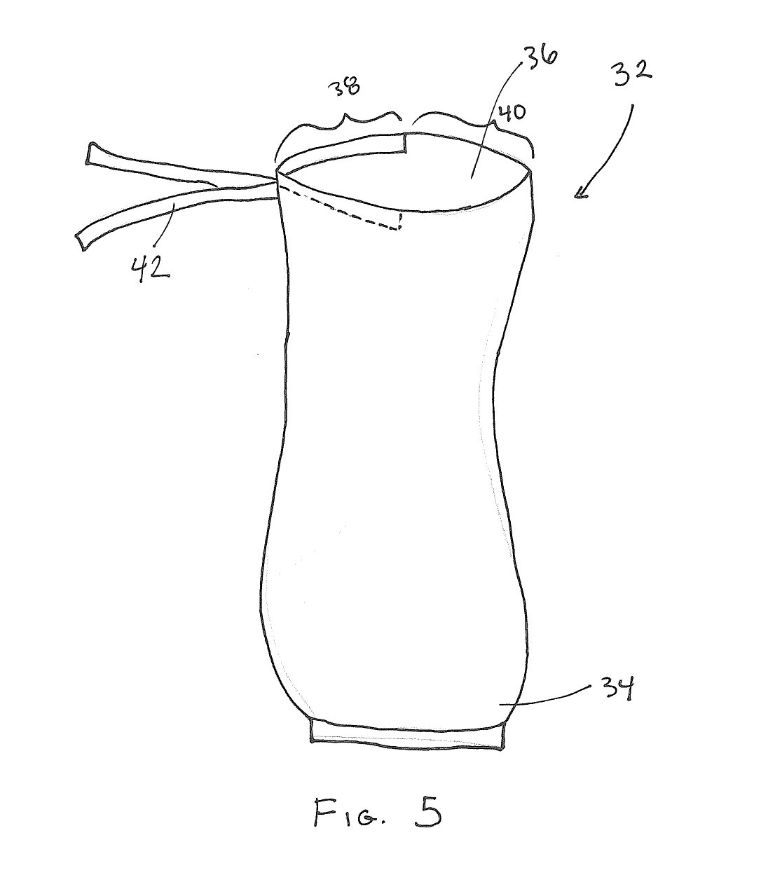

Turning to FIG. 5, it is preferred that bag 32 includes first end 34 and second end 36 and is removably attached about outer surface 24 of the discharge horn 14.

In an embodiment, first end 34 is located at the bottom of bag 32 and is selectively closable. One of ordinary skill in the art will appreciate that a variety of structures can be used to make first end 34 selectively closable, for example, loop and hook, buttons, zippers, clips, clasps, snaps, magnets etc. Additionally, second end 36 is located at the top of bag 32 and is open but has a first portion 38 that is selectively closable and a second portion 40 that is permanently open. This configuration allows bottom end 22 of discharge horn 14 to be inserted into second end 36 of bag 32, and then the selectively closable portion 38 of second end 36 of bag 32 may be closed. This will result in the opening at second end 36 of bag 32 being smaller than bottom end 22 of discharge horn 14. Consequently, bag 32 will hang on discharge horn 14.

To further assist in supporting bag 32 on discharge horn 14, bag 32 may include strap 42, preferably, proximate second end 36 of bag 32.

It is also contemplated that for discharge horn 14 with a straight outer surface 22 (such as shown in FIG. 4), ring 44 may be provided to aid in supporting bag 32 on discharge horn 14. See, FIG. 2.

Returning to FIG. 1, in order to increase the size of bag 32, without needlessly increasing the distance between discharge horn 14 and carbon dioxide source 16, in a preferred embodiment, adaptor 12 is bent. By “bent” it is meant that adaptor 12 has an angle other than 180 degrees (i.e., it is not linear).

Such an adaptor 12 will allow discharge horn 14 to be at an angle relative to carbon dioxide source 16. This will allow for more space below discharge horn 14 for bag 32 or other collection container, without having to increase the distance between discharge horn 14 and carbon dioxide source 16.

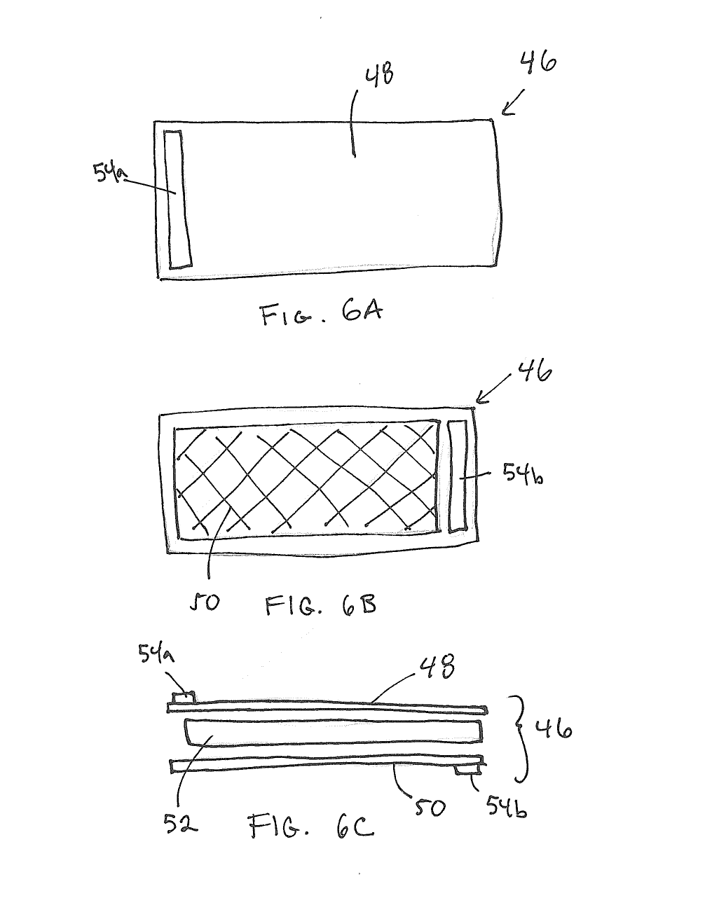

To further increase the safety of the device 10, disposed about discharge horn 14 may be an insulated sleeve 46. As shown in FIGS. 6A-6C, insulated sleeve 46 includes outer surface 48, inner surface 50, and insulating member 52 disposed there between. Preferably inner surface 50 has a texture that has a better gripping ability than a texture of outer surface 48. One of ordinary skill in the art will appreciate that a variety of materials can be used. It is contemplated that insulating member 52 form one of the surfaces 48, 50 and still fall within the language that the insulating member 52 is disposed between outer surface 48 and inner surface 50.

Insulating sleeve 46 may also include complementarily configured connecting structures 54a, 54b for example, loop and hook, buttons, zippers, clips, clasps, snaps, magnets, which will allow insulated sleeve 46 to be removably secured around discharge horn 14. It is thought that insulated sleeve 46 could be used with other discharge horn 14, and not merely those that are fixed/attached to carbon dioxide source 16.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

Claimed is:

1. A device for producing solid carbon dioxide, the device comprising:
a discharge horn having a top end, an open bottom end, an outer surface, an inner space, and a conduit;
a bent adaptor for supporting the discharge horn in a fixed position and for connecting the conduit to a source of CO₂.

2. The device of claim 1 further comprising: a discharge valve located in the inner space and distally spaced from the open bottom end.

3. The device of claim 1 further comprising: a bag having a first end and a second end and being removably attached about the outer surface of the discharge horn.

4. The device of claim 3 wherein the outer surface is tapered to support the bag.

5. The device of claim 3 wherein the outer surface includes a ring for supporting the bag.

6. The device of claim 3 wherein the bag comprises a first end being selectively closable and a second end having a first portion that is selectively closable and a second portion that is open.

7. The device of claim 3 wherein the bag further comprises a strap proximate the second end for removably attaching the bag to the outer surface of the discharge horn.

8. The device of claim 1 wherein the conduit has a 90 degree bend.

9. The device of claim 1 wherein the bent adaptor has an angle of approximately 45 degrees.

10. The device of claim 1 further comprising: an insulated sleeve capable of being removably attached to the discharge horn.

11. The device of claim 10 wherein the insulated sleeve comprises:
an outer surface having a first texture;
an inner surface having a second texture with a better gripping ability than the first texture;
an insulating member disposed between the inner surface and the outer surface; and,
an complementarily configured connecting structures for selectively attaching the insulated sleeve about a discharge horn.

12. A device for producing solid carbon dioxide, the device comprising:
a discharge horn having a top end, an open bottom end, an outer surface, an inner space, and a conduit;
a adaptor for supporting the discharge horn in a fixed position and for connecting the conduit to a source of CO₂; and,
a bag having a first end and a second end and being removably attached to the about the outer surface of the discharge horn.

13. The device of claim 12 wherein the bag comprises a first end being selectively closable and a second end having a first portion that is selectively closable and a second portion that is open.

14. The device of claim 13 wherein the bag further comprises a strap proximate the second end for removably attaching the bag to the outer surface of the discharge horn.

15. The device of claim 14 wherein the outer surface includes a flange for supporting the bag.

16. The device of claim 14 wherein the outer surface includes a ring for supporting the bag.

17. An insulated sleeve capable of being removably attached about a discharge horn, the sleeve comprising:
an outer surface having a first texture;
an inner surface having a second texture with a better gripping ability than the first texture;
an insulating member disposed between the inner surface and the outer surface; and,
an complementarily configured connecting structures for selectively attaching the sleeve about a discharge horn.
